(19) United States
(12) Patent Application Publication
(10) Pub. No.: US 2016/0154326 A1
(43) Pub. Date: Jun. 2, 2016

(54) ELECTROPHOTOGRAPHIC PHOTOSENSITIVE MEMBER, METHOD FOR PRODUCING ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Hirofumi Kumoi, Suntou-gun (JP); Shoma Hinata, Mishima-shi (JP); Masataka Kawahara, Mishima-shi (JP); Masato Tanaka, Tagata-gun (JP)

(21) Appl. No.: 14/927,300

(22) Filed: Oct. 29, 2015

(30) Foreign Application Priority Data
Nov. 28, 2014 (JP) 2014-241864

(51) Int. Cl. G03G 5/043; G03G 5/05; G03G 5/06

(52) U.S. Cl. CPC G03G 5/043; G03G 5/0696; G03G 5/0525

(57) ABSTRACT

The charge generating layer includes a gallium phthalocyanine crystal in which an organic compound (P) is contained, the organic compound (P) is at least one compound selected from the group consisting of dimethylsulfoxide, N,N-dimethylformamide, N-methylformamide, N-propylformamide, N-vinylformamide and N-methylpyrrolidone, the content of the organic compound (P) is 0.1% by mass or more and 1.5% by mass or less based on a gallium phthalocyanine in the gallium phthalocyanine crystal, and the charge transporting layer includes a resin having a siloxane structure, and a compound (Q) having a boiling point of 150° C. or more at 1 atm.

### BACKGROUND OF THE INVENTION

1. Field of the Invention

The present invention relates to an electrophotographic photosensitive member, a method for producing the electrophotographic photosensitive member and a process cartridge and an electrophotographic apparatus including the electrophotographic photosensitive member.

2. Description of the Related Art

An electrophotographic photosensitive member is generally a functional separation type laminated photosensitive member in which a charge generating function and a charge transporting function are shared in a charge generating layer and a charge transporting layer, respectively.

With respect to a charge generating substance of the charge generating layer, the emission wavelength of a semiconductor laser commonly used as an image exposing unit is as long as from 650 to 820 nm, and therefore a charge generating substance having a high sensitivity to light of a long wavelength is developed in progress.

A phthalocyanine pigment is effective as such a charge generating substance having a high sensitivity to light up to a long wavelength region, and in particular, oxytitanium phthalocyanine and gallium phthalocyanine, having excellent sensitive characteristics, have been heretofore reported with respect to various crystal forms and improved production methods.

Japanese Patent Application Laid-Open No. H07-331107 discloses a hydroxygallium phthalocyanine crystal containing a polar organic solvent. N,N-dimethylformamide is used for a conversion solvent to thereby allow the polar organic solvent to be incorporated in the crystal, providing a crystal having excellent sensitive characteristics.

On the other hand, electrical and mechanical external forces such as charging, exposing, developing, transferring and cleaning external forces are directly applied to the charge transporting layer that is a surface layer of an electrophotographic photosensitive member, and thus durability to such external forces is demanded. In particular, with respect to cleaning, the charge transporting layer is demanded to also have a reduced frictional force (lubricating property) to a contacting member (cleaning blade or the like). Particularly, at the start of use of an electrophotographic apparatus, no developing agent having a lubricating effect is present on the surface of the electrophotographic photosensitive member, and therefore it is necessary to impart lubricating property on the surface of the electrophotographic photosensitive member.

For the purpose of imparting lubricating property on the surface of the electrophotographic photosensitive member, Japanese Patent Application Laid-Open No. H07-13368 proposes a method in which a silicone oil such as polydimethylsiloxane is added to a surface layer of an electrophotographic photosensitive member.

### SUMMARY OF THE INVENTION

The present inventors have made studies, and as a result, it has found that, while the electrophotographic photosensitive member described in Japanese Patent Application Laid-Open No. H07-331107 has excellent sensitive characteristics, photomemory as electrical degradation after repeated use may be caused. The photomemory is caused by retention of a carrier in a photosensitive layer, the carrier being generated by exposing the electrophotographic photosensitive member to light of a fluorescent lamp or the like during maintenance of a process cartridge and an electrophotographic apparatus after repeated use. If image formation is performed in such a condition, the difference in potential is caused between a region exposed to light and a region not exposed to light, resulting in image defects having density irregularities on an image. In the electrophotographic photosensitive member described in Japanese Patent Application Laid-Open No. H07-13368, a surface layer after addition may be clouded to easily cause image defects such as a reduction in density and irregularities.

In recent years, speed-up of an electrophotographic process has been advanced, and a high-quality image with no image defects has been demanded to be formed in use in a high-speed process.

The present invention is directed to providing an electrophotographic photosensitive member that can have an improved charge generating material in a charge generating layer and an improved charge transporting layer, such improvements being simultaneously achieved, to thereby allow a high-quality image to be output while a good cleaning property is achieved from the start of use even by use in a high-speed process and photomemory after repeated use is suppressed.

Further, the present invention is directed to providing a method for producing the electrophotographic photosensitive member, a process cartridge and an electrophotographic apparatus including the electrophotographic photosensitive member.

According to one aspect of the present invention, there is provided an electrophotographic photosensitive member including a support, and a charge generating layer and a charge transporting layer on the support, wherein the charge generating layer includes a gallium phthalocyanine crystal in which an organic compound (P) is contained, wherein the organic compound (P) is at least one compound selected from the group consisting of dimethylsulfoxide, N,N-dimethylformamide, N-methylformamide, N-propylformamide, N-vinylformamide and N-methylpyrrolidone, the content of the organic compound (P) is 0.1% by mass or more and 1.5% by mass or less based on a gallium phthalocyanine in the gallium phthalocyanine crystal, and the charge transporting layer includes a resin having a siloxane structure, and a compound (Q) having a boiling point of 150° C. or more at 1 atm.

According to another aspect of the present invention, there is provided a method for producing the electrophotographic photosensitive member, the method including drying a coating film of a coating liquid containing the gallium phthalocyanine crystal in which an organic compound (P) is contained, to form a charge generating layer, and drying a coating film of a coating liquid containing the resin having a siloxane structure, to form a charge transporting layer.

According to further aspect of the present invention, there is provided a process cartridge detachably attachable to a main body of an electrophotographic apparatus, wherein the process cartridge integrally supports the electrophotographic photosensitive member, and at least one unit selected from the group consisting of a charging unit, a developing unit and a cleaning unit.

According to further aspect of the present invention, there is provided an electrophotographic apparatus including the electrophotographic photosensitive member, and a charging unit, an exposing unit, a developing unit and a transfer unit.

Further features of the present invention will become apparent from the following description of exemplary embodiments with reference to the attached drawings.

### BRIEF DESCRIPTION OF THE DRAWINGS

FIG. 1 is a view illustrating one example of a schematic configuration of an electrophotographic apparatus provided with a process cartridge including the electrophotographic photosensitive member of the present invention.

FIG. 2 is a powder X-ray diffraction diagram of a hydroxygallium phthalocyanine crystal obtained in Example 1-1.

FIG. 3 is a powder X-ray diffraction diagram of a chlorogallium phthalocyanine crystal obtained in Example 1-13.

### DESCRIPTION OF THE EMBODIMENTS

Preferred embodiments of the present invention will now be described in detail in accordance with the accompanying drawings.

The electrophotographic photosensitive member of the present invention includes, as described above, a support, and a charge generating layer and a charge transporting layer on the support.

The charge generating layer includes a gallium phthalocyanine crystal in which an organic compound (P) is contained, and the content of the organic compound (P) is 0.1% by mass or more and 1.5% by mass or less based on a gallium phthalocyanine in the gallium phthalocyanine crystal. The organic compound (P) is at least one compound selected from the group consisting of dimethylsulfoxide, N,N-dimethylformamide, N-methylformamide, N-propylformamide, N-vinylformamide or N-methylpyrrolidone.

Then, the charge transporting layer includes a resin having a siloxane structure.

The resin having a siloxane structure included in the charge transporting layer includes a resin having a structural unit represented by the following formula (A) (polyester resin or polycarbonate resin):

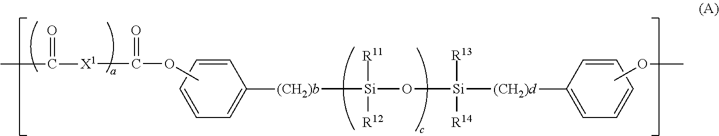

wherein, in the formula (A), R¹¹ to R¹⁴ represent any selected from a hydrogen atom, a substituted or unsubstituted alkyl group, and a substituted or unsubstituted aryl group; “a” represents an integer of 0 or 1; “b” and “d” represent an integer of 1 to 20; represents an integer of 1 to 500; and X¹ represents a m-phenylene group, a p-phenylene group, or a divalent group in which two p-phenylene groups are bound via an oxygen atom.

Furthermore, the resin having the structural unit of the formula (A) can be a copolymer having a structural unit of the following formula (B):

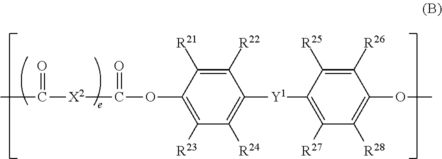

wherein, in the formula (B), R²¹ to R²⁸ each independently represent a hydrogen atom, an alkyl group, an aryl group or an alkoxy group; represents a single bond, a cycloalkylidene group of a substituted or unsubstituted 5- to 8-membered ring, or a divalent group shown below, in which the substituent of the cycloalkylidene group of the 5- to 8-membered ring is an alkyl group having 1 to 3 carbon atoms; “e” represents an integer of 0 or 1; and X² represents a m-phenylene group, a p-phenylene group, or a divalent group in which two p-phenylene groups are bound via an oxygen atom;

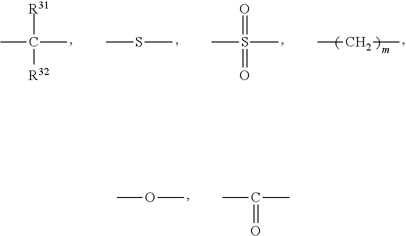

wherein R³¹ and R³² represent a hydrogen atom, a halogen atom, a substituted or unsubstituted alkyl group, a substituted or unsubstituted aryl group, or a substituted or unsubstituted alkenyl group; and m represents an integer of 2 to 5.

Hereinafter, specific examples of the structural unit of the formula (A) and the structural unit of the formula (B) are shown.

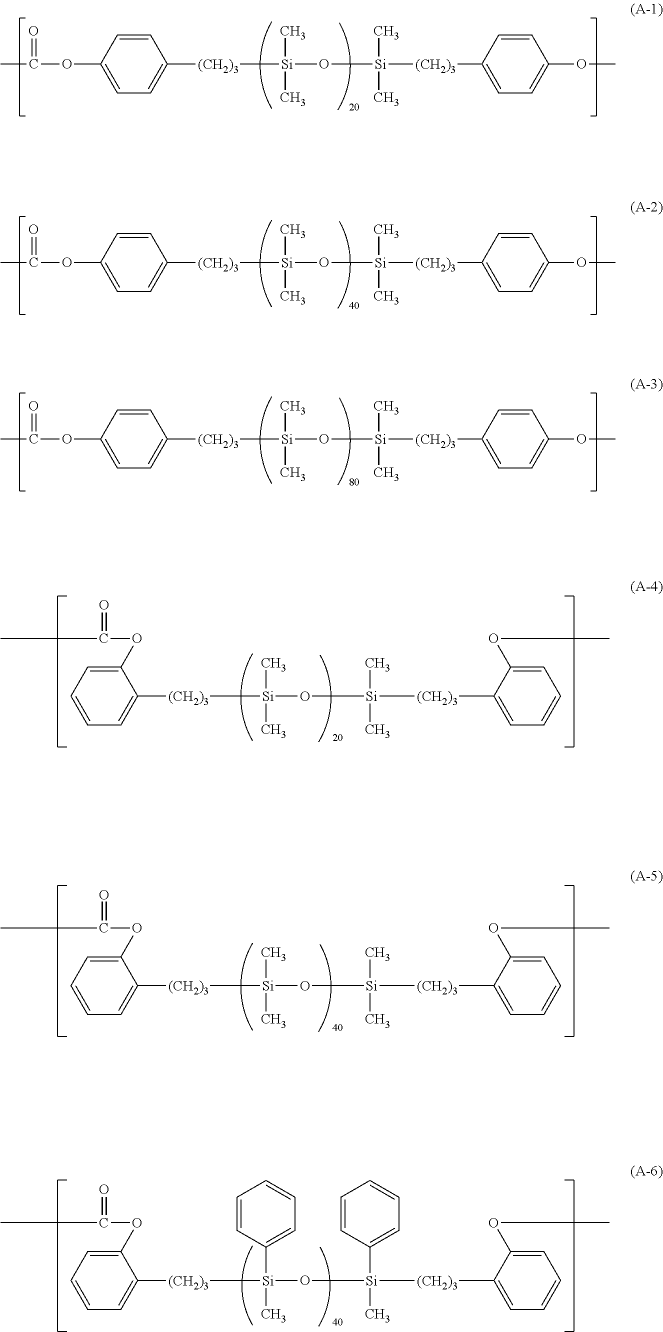

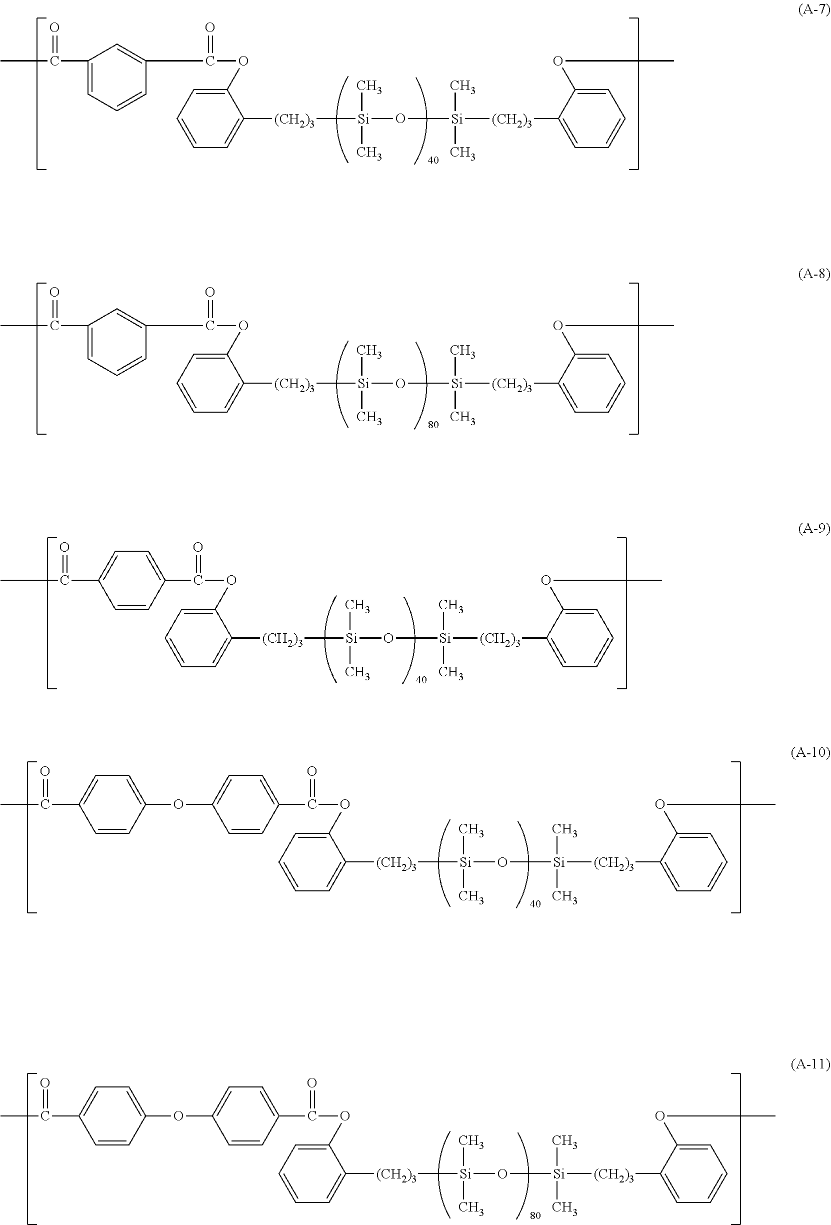

The structural unit of the formula (A) can be a structural unit represented by any of (A-4), (A-5), (A-7), (A-8) , (A-10) and (A-11).

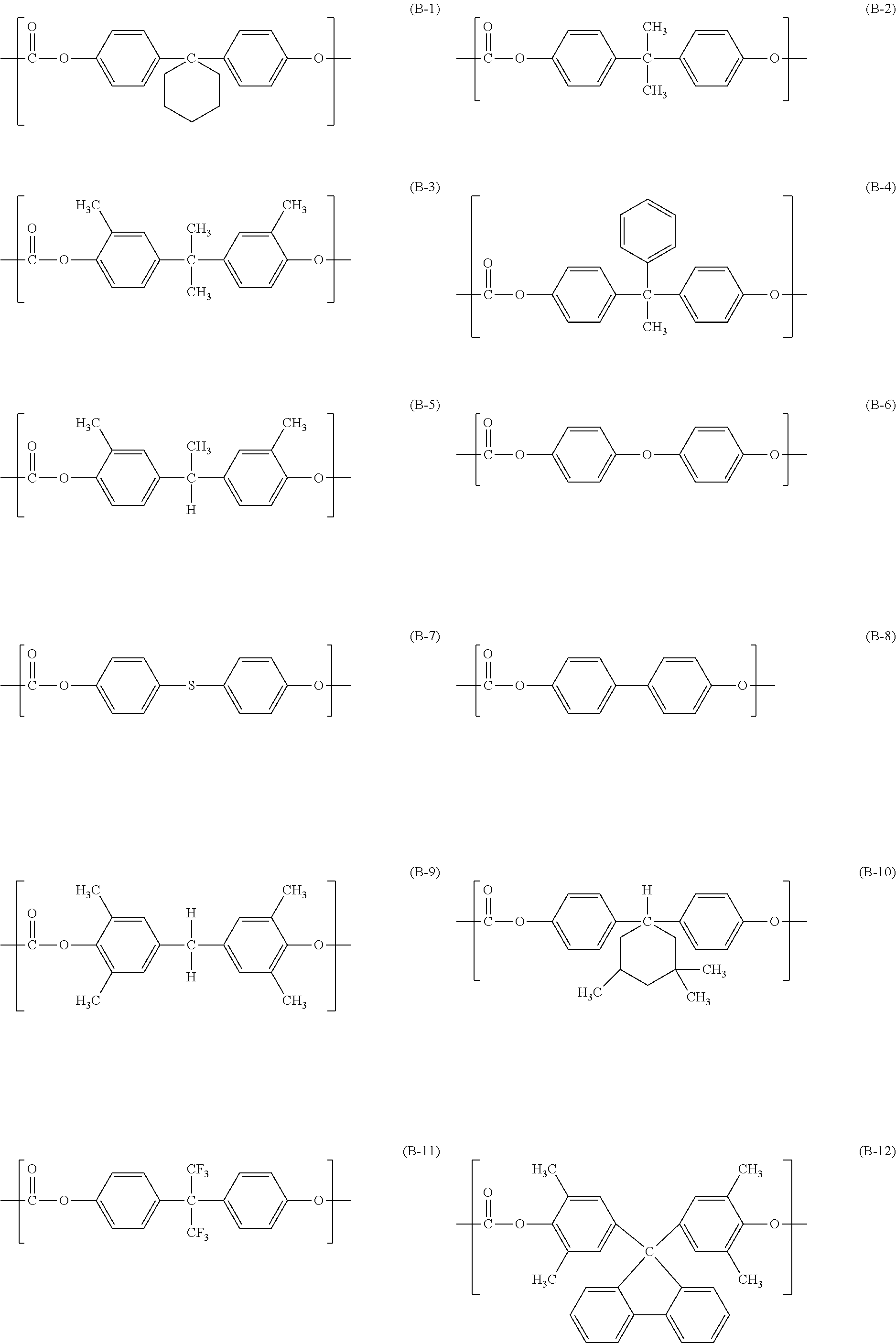

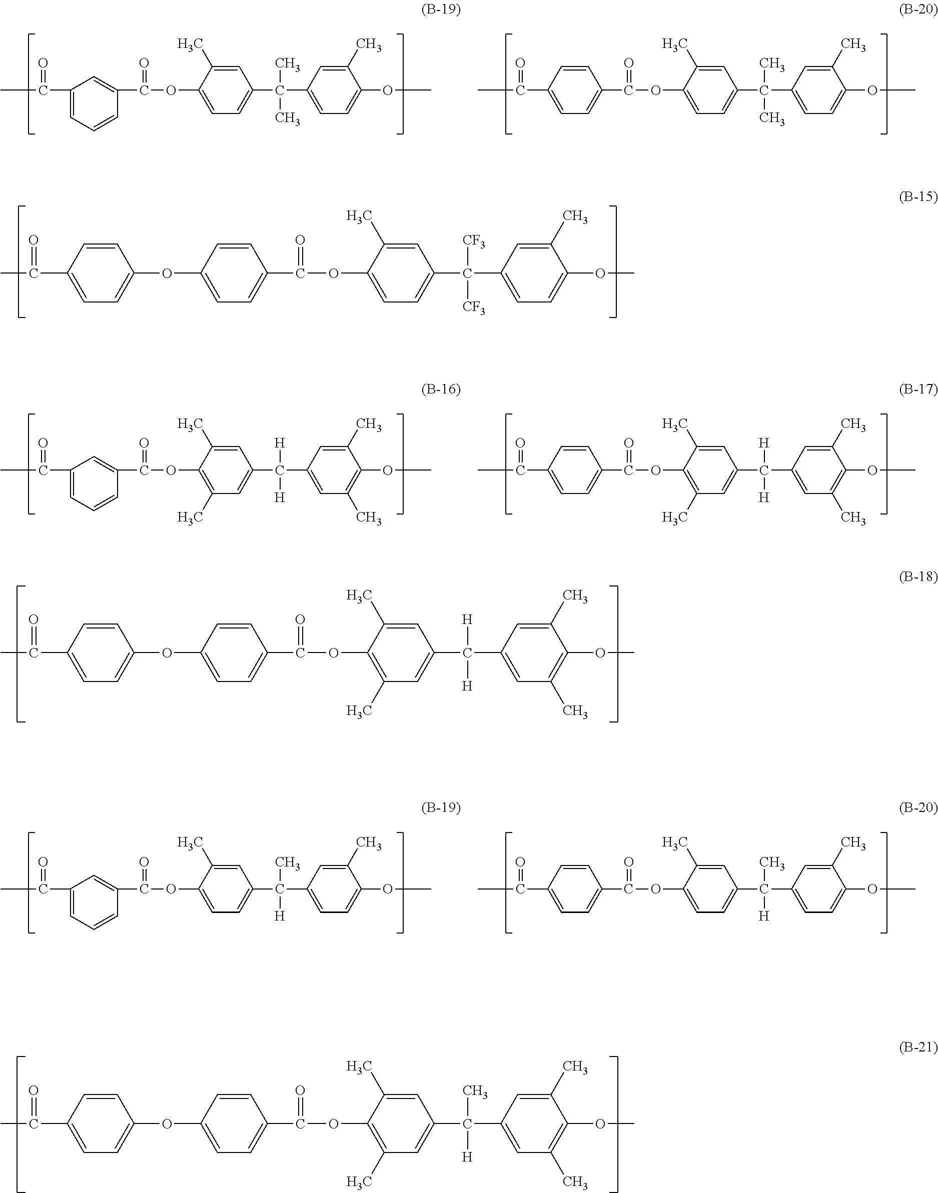

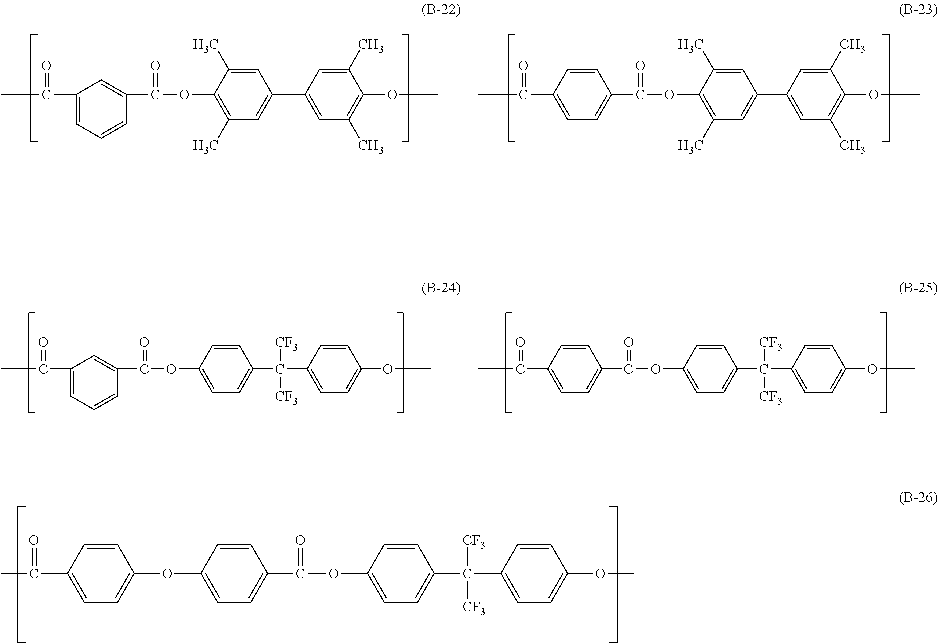

The structural unit of the formula (B) can be a structural unit represented by any of (B-10), (B-12), (B-13) , (B-14) , (B-16) , (B-17) , (B-21) , (B-22) and (B-23).

With respect to the resin having a siloxane structure, specific examples of the resin (copolymer) having the structural unit of the formula (A) and the structural unit of the formula (B) are shown in Table 1. In Table 1, PC and PE represent a polycarbonate resin and a polyester resin, respectively. In addition, numerical values in parentheses in the columns “Structural unit of formula (A)” and “Structural unit of formula (B)” represent mixing ratios.

TABLE 1

| | | | Polymerization ratio | |
|---|---|---|---|---|
| Resin having | | | (molar ratio) of | Weight average |
| siloxane | Structural unit of | Structural unit of | formula (A) and | molecular |
| structure | formula (A) | formula (B) | formula (B) | weight |
| PC-1 | A-1 | B-1 | 1:9 | 50000 |
| PC-2 | A-4 | B-1 | 1:9 | 40000 |
| PC-3 | A-5 | B-1 | 1:7 | 40000 |
| PC-4 | A-4 | B-6 | 1:9 | 50000 |
| PC-5 | A-4 | B-8 | 1:9 | 60000 |
| PC-6 | A-4 | B-10 | 1:9 | 40000 |
| PC-7 | A-4 | B-11 | 1:9 | 50000 |
| PC-8 | A-4 | B-12 | 2:8 | 40000 |
| PC-9 | A-4 | B-1 + B-11(6/2.5) | 1.5:8.5 | 60000 |
| PE-1 | A-7 + A-9(5/5) | B-13 + B-14(5/5) | 1:9 | 40000 |
| PE-2 | A-7 + A-9(5/5) | B-16 + B-17(7/3) | 2:8 | 50000 |
| PE-3 | A-7 + A-9(5/5) | B-22 + B-23(5/5) | 1:9 | 40000 |
| PE-4 | A-7 + A-9(5/5) | B-24 + B-25(7/3) | 3:7 | 40000 |

The copolymerization form of the polycarbonate resin and the polyester resin may be any form such as block copolymerization, random copolymerization or alternating copolymerization.

The polycarbonate resin and the polyester resin can be synthesized by a known method. For example, the resins can be synthesized by the methods described in Japanese Patent Application Laid-Open No. 2007-047655 and Japanese Patent Application Laid-Open No. 2007-072277. Also in the present invention, the same synthesis methods are used.

The weight average molecular weights of the polycarbonate resin and the polyester resin are preferably 20,000 or more and 300,000 or less, more preferably 40,000 or more and 200,000 or less. In the present invention, the weight average molecular weights of the resins mean the weight average molecular weights in terms of polystyrene measured by the method described in Japanese Patent Application Laid-Open No. 2007-79555, according to an ordinary method.

The polycarbonate resin and the polyester resin may each have a structure having a siloxane structure at the terminal. The siloxane structure at the terminal is represented by formula (C):

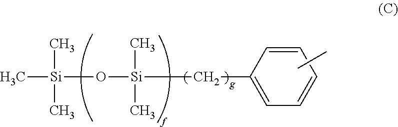

wherein, in the formula (C), “f” and “g” represent the number of repetitions of the structure in parentheses, and with respect to the polycarbonate resin or the polyester resin, the average of f is 20 or more and 100 or less and the average of g is 1 or more and 10 or less. More preferably, the average of f is 30 or more and 60 or less and the average of g is 3 or more and 10 or less.

The siloxane resin having the structural unit of the formula (A) and the structural unit of the formula (B) can have a terminal structure represented by the formula (C) at one terminal or both terminals of the resin. When the resin has the terminal structure represented by the formula (C) at one terminal thereof, a molecular weight modifier (end-capping agent) is used. Examples of the molecular weight modifier include phenol, p-cumylphenol, p-tert-butylphenol and benzoic acid. In the present invention, phenol or p-tert-butylphenol can be adopted.

When the resin has the terminal structure represented by the formula (C) at one terminal thereof, a structure at the other terminal (other terminal structure) is a structure represented below.

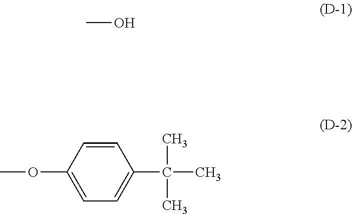

Herein, in the formula (C) and the formula (D-2), when the terminal of each of the structural unit of the formula (A) and the structural unit of the formula (B) is an oxygen atom, a carbonyl group is required to be located between the terminal and each of the structural units. In the formula (D-1), when the terminal of each of the structural unit of the formula (A) and the structural unit of the formula (B) is an oxygen atom, the oxygen atom of the formula (D-1) is not required to be located.

Hereinafter, specific examples of the terminal siloxane structure represented by the formula (C) are shown. In particular, structures of (C-2) and (C-4) can be adopted.

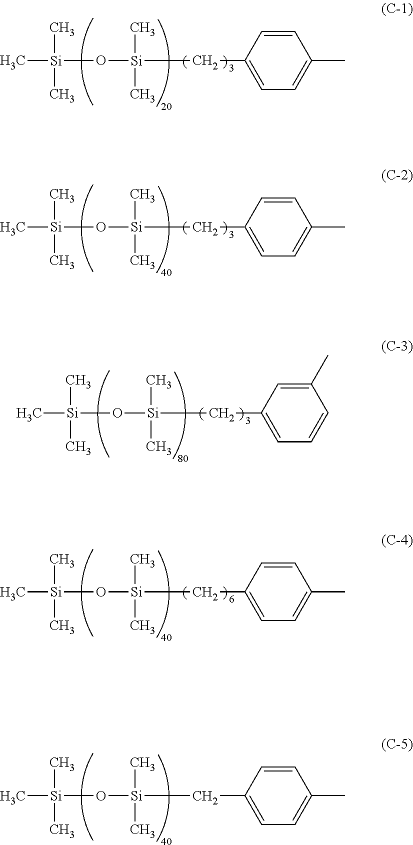

Herein, in the resin having the siloxane structures in the formula (A) and formula (C), the siloxane structures mean structures in dotted frames, as represented by the following formulae.

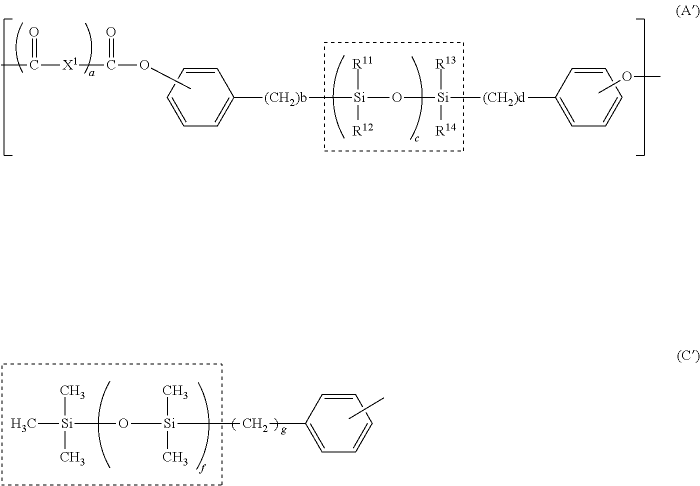

In the present invention, the polycarbonate resin and the polyester resin can be synthesized by a known method. For example, the resins can be synthesized by the method described in Japanese Patent Application Laid-Open No. 2007-199688.

Also in the present invention, the same synthesis method is used, and raw materials depending on a polycarbonate resin and a polyester resin are used to synthesize each polycarbonate resin and each polyester resin shown in Table 2. Herein, the polycarbonate resin and the polyester resin obtained are fractionated and separated using size exclusion chromatography, and thereafter respective components fractionated are subjected to ¹H-NMR measurement, and the resin composition is identified from the relative ratio of the siloxane moiety in the resin. Specific examples of the polycarbonate resin and the polyester resin synthesized are shown in Table 2.

TABLE 2

| Resin | | | Polymerization | Terminal | Terminal | Weight |
|---|---|---|---|---|---|---|
| having | | | ratio (molar ratio) | structure | structure | average |
| siloxane | Structural unit | Structural unit | of formula (A) | at one | at other | molecular |
| structure | of formula (A) | of formula (B) | and formula (B) | terminal | terminal | weight |
| PC-10 | — | B-1 | — | C-2 | C-2 | 40000 |
| PC-11 | — | B-8 | — | C-1 | D-1 | 50000 |
| PC-12 | A-4 | B-1 | 2:8 | C-2 | D-2 | 60000 |
| PC-13 | A-5 | B-1 | 1:7 | C-2 | C-2 | 50000 |
| PE-5 | — | B-13 + B-14(5/5) | — | C-2 | C-2 | 40000 |
| PE-6 | — | B-22 + B-23(5/5) | — | C-2 | D-2 | 40000 |
| PE-7 | A-7 + A-9(5/5) | B-24 + B-25(7/3) | 2:8 | C-2 | C-2 | 50000 |
| PE-8 | A-7 + A-9 + A-10 + A-11 | B-24 + B-25(7/3) | 2:8 | C-2 | C-2 | 60000 |
| | (2.25/0.75/5.25/1.75) | | | | | |

In the present invention, the resin having a siloxane structure may be an acrylic resin having a structural unit represented by the following formula (E). In particular, the resin can be a copolymer of a structural unit represented by the following formula (E) and a structural unit represented by the following formula (F) or the following formula (G):

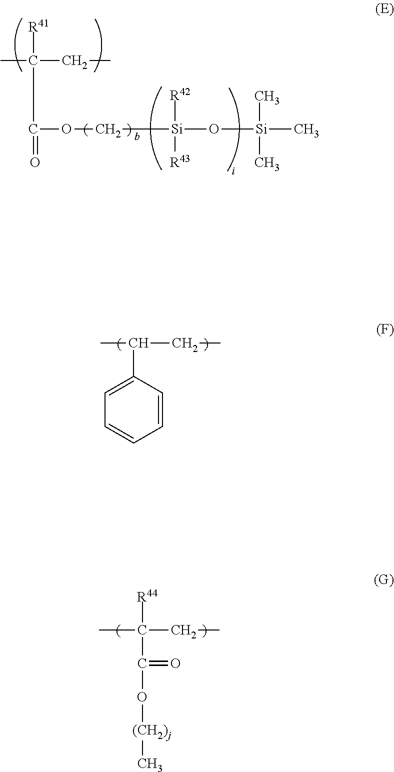

wherein, in the formula (E), R⁴¹ represents hydrogen or a methyl group; h represents the number of repetitions of the structure in parentheses and the average of h is 0 or more and 5 or less; R⁴² to R⁴³ each independently represent a methyl group, a methoxy group or a phenyl group; i represents the number of repetitions of the structure in parentheses and the average of i is 10 or more and 50 or less; and in the formula (G), R⁴⁴ represents hydrogen, a methyl group or a phenyl group; and j represents 0 or 1.

A siloxane structure of the acrylic resin having the structural unit represented by the formula (E) means a structure in a dotted frame, as represented by the following formula.

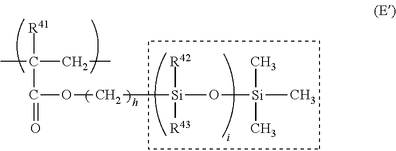

Specific examples of the structural unit represented by the formula (E) are shown below.

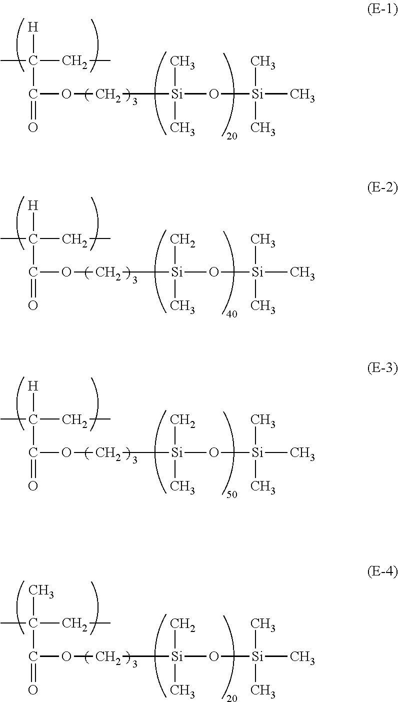

Specific examples of the structural unit represented by the formula (G) are shown below.

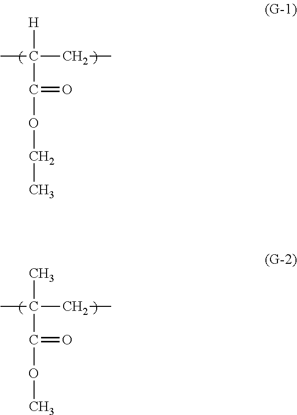

Synthesis Example of the acrylic resin having a siloxane structure is shown in Table 3. In particular, a resin represented by any of AC-1 and AC-2 can be adopted.

TABLE 3

| | | | Polymerization ratio | |
|---|---|---|---|---|
| Resin | | Structural | (molar ratio) of | Weight |
| having | Structural | unit | formula (E) | average |
| siloxane | unit of | of formula (F) | and formula (F) | molecular |
| structure | formula (E) | or formula (G) | or formula (G) | weight |
| AC-1 | E-1 | F | 1:9 | 100000 |
| AC-2 | E-2 | F | 1:9 | 90000 |
| AC-3 | E-3 | G-2 | 2:8 | 100000 |

Such an acrylic resin can be synthesized by a known method, for example, the method described in Japanese Patent Application Laid-Open No. 558-167606 or Japanese Patent Application Laid-Open No. S62-75462.

In the present invention, a resin free from a siloxane structure, as a binder resin, can be used in combination with the resin having a siloxane structure. Examples of the resin free from a siloxane structure include a resin having the structural unit represented by the formula (B).

The content of the resin having a siloxane structure in the charge transporting layer of the electrophotographic photosensitive member of the present invention is preferably 0.1% by mass or more and 50% by mass or less, more preferably 1% by mass or more and 40% by mass or less, based on the total mass of the total resin included in the charge transporting layer.

The charge transporting layer in the present invention can include at least one compound (Q) having a boiling point of 150° C. or more at 1 atm. For the compound (Q), methyl benzoate (boiling point: 198° C., melting point: −15° C.), ethyl benzoate (boiling point: 213° C., melting point: −34° C.), benzyl acetate (boiling point: 212° C., melting point: −51° C.), ethyl 3-ethoxypropionate (boiling point: 166° C., melting point: −75° C.), diethylene glycol ethyl methyl ether (boiling point: 179° C., melting point: 72° C.), propylene carbonate (boiling point: 240° C., melting point: −55° C.) and y-butyrolactone (boiling point: 204° C., melting point: −44° C.) can be adopted.

The compound (Q) can be liquid at a temperature of 23° C. and at 1 atm.

Such a compound can be included to thereby enhance lubricating property of the charge transporting layer, and the effect of suppressing photomemory after repeated use. The content of the compound (Q) is preferably 0.001% by mass or more and 2% by mass or less, more preferably 0.001% by mass or more and 1.5% by mass or less, based on the total mass of the charge transporting layer.

In the present invention, the compound (Q) is contained in a coating liquid for a charge transporting layer, a coating film of the coating liquid for a charge transporting layer is formed, and the coating film is heated and dried to form a charge transporting layer.

In the present invention, the compound (Q) is easily volatilized by the heating and drying step in formation of the charge transporting layer, and therefore the content of the compound (Q) to be added to the coating liquid for a charge transporting layer can be higher than the content of the compound (Q) in the charge transporting layer. Accordingly, the content of the compound (Q) to be added to the coating liquid for a charge transporting layer is preferably 5% by mass or more and 50% by mass or less, more preferably 5% by mass or more and 40% by mass or less, based on the total mass of the coating liquid for a charge transporting layer.

The content of the compound (Q) in the charge transporting layer can be determined by a measurement method as follows. The measurement is performed using an HP7694 Headspace sampler (manufactured by Agilent Technologies, Inc.) and an HP6890 series GC System (manufactured by Agilent Technologies, Inc.). The charge transporting layer of the electrophotographic photosensitive member produced is cut to a piece of 5 mm×mm (sample piece), the piece obtained by cutting is placed in a vial container. A Headspace sampler (HP7694 Headspace sampler) is set as follows: Oven: 150° C.; Loop: 170° C.; and Transfer Line: 190° C.; the vial container is heated at such settings, and a gas generated is subjected to measurement by gas chromatography (HP6890 series GC System). The mass of the charge transporting layer is determined from the difference between the mass of the sample piece taken out from the vial container after measurement, and the mass of the sample piece from which the charge transporting layer is peeled. The sample piece from which the charge transporting layer is peeled is obtained by immersion in methyl ethyl ketone for 5 minutes, peeling of the charge transporting layer, and thereafter drying at 100° C. for 5 minutes.

Next, the gallium phthalocyanine crystal of the present invention contains the organic compound (P) therein. The organic compound (P) may be of a plurality of organic compounds, and the content of the organic compound is 0.1% by mass or more and 1.5% by mass or less based on a gallium phthalocyanine compound in the gallium phthalocyanine crystal. The content of the organic compound (P) is more preferably 0.3% by mass or more and 1.2% by mass or less based on a gallium phthalocyanine compound in the gallium phthalocyanine crystal.

The organic compound (P) can be at least one selected from the group consisting of N-methylformamide, N-propylformamide or N-vinylformamide. Furthermore, the organic compound (P) and the compound (Q) can be miscible with each other.

As the gallium phthalocyanine crystal, a hydroxygallium phthalocyanine crystal, a chlorogallium phthalocyanine crystal, a bromogallium phthalocyanine crystal and an iodogallium phthalocyanine crystal having an excellent sensitivity can act effectively to the object of the present invention and are preferable. In particular, the gallium phthalocyanine crystal is particularly preferably a hydroxygallium phthalocyanine crystal or a chlorogallium phthalocyanine crystal. The hydroxygallium phthalocyanine crystal has a hydroxy group as an axial ligand to a gallium atom. The chlorogallium phthalocyanine crystal has a chlorine atom as an axial ligand to a gallium atom. The bromogallium phthalocyanine crystal has a bromine atom as an axial ligand to a gallium atom. The iodogallium phthalocyanine crystal has an iodine atom as an axial ligand to a gallium atom.

The hydroxygallium phthalocyanine crystal is more preferably a hydroxygallium phthalocyanine crystal having peaks at Bragg angles 2θ of 7.4°±0.3° and 28.3°±0.3° in CuKα characteristic X-ray diffraction, in terms of high sensitivity.

The chlorogallium phthalocyanine crystal is more preferably a chlorogallium phthalocyanine crystal having peaks at Bragg angles 2θ±0.2° of 7.4°, 16.6°, 25.5° and 28.3° in CuKα characteristic X-ray diffraction, in terms of high sensitivity.

The method for producing the gallium phthalocyanine crystal in which the organic compound (P) is contained is described.

The gallium phthalocyanine crystal in which the organic compound (P) is contained, in the present invention, is obtained in a step of adding the gallium phthalocyanine to a solvent including the organic compound and subjecting the resultant to a wet milling treatment to thereby perform crystal transformation of the gallium phthalocyanine. The gallium phthalocyanine crystal is obtained by the milling treatment using the solvent including organic compound (P). The gallium phthalocyanine for use in the wet milling treatment can be a gallium phthalocyanine obtained by an acid pasting method or a dry milling treatment.

The wet milling treatment here conducted is, for example, a treatment conducted using a milling apparatus such as a sand mill or a ball mill together with a dispersant such as glass beads, steel beads or an alumina ball. The wet milling time can be about 30 to 3000 hours. In particular, a method can be adopted in which a sample is taken every 10 to 100 hours, and the content of the organic compound (P) in the gallium phthalocyanine crystal is confirmed by ¹H-NMR measurement. The mass of the dispersant for use in the wet milling treatment can be 10 to 50 times the amount of the gallium phthalocyanine on a mass basis.

The amount of the organic compound (P) to be used can be 5 to 30 times the amount of the gallium phthalocyanine crystal on a mass basis.

The content of the organic compound (P) in the gallium phthalocyanine crystal in the present invention can be determined by ¹H-NMR measurement of the gallium phthalocyanine crystal.

X-ray diffraction and 1H-NMR measurements of the gallium phthalocyanine crystal contained in the electrophotographic photosensitive member of the present invention are performed under the following conditions. (Powder X-ray diffraction measurement)

Measurement machine used: X-ray diffraction apparatus RINT-TTRII manufactured by Rigaku Corporation
X-ray tube bulb: Cu
Tube voltage: 50 KV
Tube current: 300 mA
Scanning method: 20/0 scanning
Scanning speed: 4.0°/min
Sampling interval: 0.02°
Start angle (20): 5.0°
Stop angle (20): 40.0°
Attachment: standard specimen holder
Filter: not used
Incident monochromator: used
Counter monochromator: not used
Divergence slit: open
Vertical divergence limitation slit: 10.00 mm
Scattering slit: open
Light-receiving slit: open
Flat plate monochromator: used
Counter: scintillation counter
(¹H-NMR measurement)
Measurement instrument used: AVANCEIII 500 manufactured by Bruker Corporation
Solvent: deuterosulfuric acid (D₂SO₄)

The photosensitive layer in the present invention is a laminated photosensitive member obtained by laminating the charge generating layer including the gallium phthalocyanine crystal in which the organic compound (P)is contained (hereinafter, abbreviated as “organic compound (P)-containing gallium phthalocyanine crystal”), and the charge transporting layer including the resin having a siloxane structure. A lamination relationship between the charge generating layer and the charge transporting layer is as follows: the charge generating layer corresponds to an underlayer.

The support for use in the electrophotographic photosensitive member of the present invention can be one having electro-conductivity (electro-conductive support). Examples include metals and alloys such as aluminum and stainless steel, or metals, alloys, plastics and paper provided with the electro-conductive layer. The shape of the support includes a cylindrical shape or a film shape.

In the present invention, an undercoat layer (intermediate layer) having a barrier function and an adhesion function can also be provided between the support and the photosensitive layer.

For the material of the undercoat layer, polyvinyl alcohol, polyethylene oxide, ethyl cellulose, methyl cellulose, casein, polyamide, glue, gelatin and the like are used. The undercoat layer can be formed by coating the support with a coating liquid for an undercoat layer, containing the above material, to form a coating film, and drying the coating film. A metal oxide may also be added as a resistance control agent.

The thickness of the undercoat layer can be 0.3 to 5.0 μm.

Furthermore, an electro-conductive layer for the purposes of covering of irregularities and defects of the support and prevention of interference fringes can be provided between the support and the undercoat layer.

The electro-conductive layer can be formed by dispersing an electro-conductive particle such as carbon black, a metal particle and a metal oxide in a binder resin.

The thickness of the electro-conductive layer is preferably 5 to 40 μm, particularly preferably 10 to 30 μm.

The charge generating layer can be formed by coating of a coating liquid for a charge generating layer, the coating liquid being prepared by dispersing the organic compound (P)-containing gallium phthalocyanine crystal and the binder resin in a solvent, and drying of the resulting coating film.

The thickness of the charge generating layer is preferably 0.05 to 1 μm, more preferably 0.1 to 0.3 μm.

The content of the organic compound (P)-containing gallium phthalocyanine crystal in the charge generating layer, is preferably 40% by mass or more and 85% by mass or less, more preferably 60% by mass or more and 80% by mass or less based on the total mass of the charge generating layer.

Examples of the binder resin for use in the charge generating layer include resins such as polyester, an acrylic resin, polycarbonate, polyvinyl butyral, polystyrene, polyvinyl acetate, polysulfone, an acrylonitrile copolymer and polyvinyl benzal. In particular, polyvinyl butyral or polyvinyl benzal can be adopted in terms of dispersibility of the gallium phthalocyanine crystal.

The charge transporting layer can be formed by coating of a coating liquid for a charge transporting layer, the coating liquid being prepared by dissolving the charge transporting material, the resin having a siloxane structure, and the binder resin (resin free from a siloxane structure) in a solvent, and drying of the resulting coating film.

For the solvent for use in preparation of the charge transporting layer of the electrophotographic photosensitive member according to the present invention, ketone type solvents such as acetone and methyl ethyl ketone; ester type solvents such as methyl acetate and ethyl acetate; aromatic hydrocarbon solvents such as toluene, xylene and chlorobenzene; ether type solvents such as 1,4-dioxane and tetrahydrofuran; hydrocarbon solvents such as chloroform substituted with a halogen atom; and the like are used. Such solvents may be used singly or as a mixture of two or more.

In particular, from the viewpoint of favorably dissolving the charge transporting material, the resin having a siloxane structure, and the binder resin (resin free from a siloxane structure), an aromatic hydrocarbon solvent such as toluene, xylene or chlorobenzene is preferable. Moreover, in terms of environmental responsiveness, in particular, toluene or xylene is more preferably used. Furthermore, in terms of uniformity of the coating film, the aromatic hydrocarbon solvent may also be used in combination with a low-boiling solvent such as dimethoxymethane or tetrahydrofuran.

In the present invention, the above solvent can be used with being mixed with the compound (Q) as a solvent. The boiling point of the compound (Q) is 150° C. or more, and a solvent having a higher boiling point than the boiling points of the aromatic hydrocarbon solvent and the low-boiling solvent is used. Such a solvent configuration allows the proportion of the compound (Q) in the coating film to be higher in the drying step after coating of the coating liquid for a charge transporting layer. The compound (Q) in the coating film mediates to thereby reduce compatibility of the resin having a siloxane structure with the binder resin, allowing both the resins in the coating film to be easily separated. Therefore, it is considered that the resin having a siloxane structure, which easily moves to the surface in drying as compared with the binder resin, moves farther from the vicinity of the interface between the charge generating layer and the charge transporting layer. Here, an electrophotographic photosensitive member having a charge transporting layer excellent in lubricating property is obtained from the start of use.

The thickness of the charge transporting layer is preferably 5 to 40 μm, particularly preferably 7 to 25 μm. The content of the charge transporting substance is preferably 20 to 80% by mass, particularly preferably 30 to 60% by mass based on the total mass of the charge transporting layer.

The charge transporting substance includes various triarylamine compounds, hydrazone compounds, stilbene compounds, pyrazoline compounds, oxazole compounds, thiazole compounds and triallylmethane compounds. In particular, a triarylamine compound can be adopted as the charge transporting substance.

A release agent for the purpose of an increase in transfer efficiency of a toner, and a filler for the purpose of prevention of abrading may also be added to the charge transporting layer.

For the coating method of each of the layers, a coating method such as a dip-coating method (dipping method), a spray coating method, a spinner coating method, a bead coating method, a blade coating method and a beam coating method can be used.

In the present invention, the gallium phthalocyanine crystal containing the organic compound (P) in the present invention can be used in the charge generating layer and the resin having a siloxane structure can be used in the charge transporting layer to thereby achieve a good cleaning property from the start of use, and at the same time suppress photomemory even in the case of wearing by repeated use in a high-speed process. As described above, the resin having a siloxane structure easily moves to the surface of the charge transporting layer during drying in formation of the charge transporting layer. Therefore, the charge transporting material is easily compatible with the binder resin at the interface with the charge generating layer. Here, it is considered that the gallium phthalocyanine crystal containing the organic compound (P) is here used as the charge generating material to allow the condition of the interface between the charge generating layer and the charge transporting layer to shift in a remarkably advantageous manner for movement of a carrier, decreasing retention of a carrier to suppress photomemory.

Furthermore, it has been revealed that the compound (Q) is used for the coating liquid for a charge transporting layer in coating of the charge transporting layer to thereby not only improve lubricating property described above, but also suppress photomemory. The following two reasons are considered therefor.

First, a reason is considered in which, as described above, the resin having a siloxane structure easily moves from the interface between the charge generating layer and the charge transporting layer to the surface of the charge transporting layer, thereby allowing carrier movement at the interface between the charge generating layer and the charge transporting layer to be advantageous.

Furthermore, a reason is considered in which the organic compound (P) of the gallium phthalocyanine crystal is miscible with the compound (Q) of the coating liquid for a charge transporting layer, thereby alleviating the barrier to carrier movement at the interface between the charge transporting layer and the charge generating layer to allow a carrier to easily move.

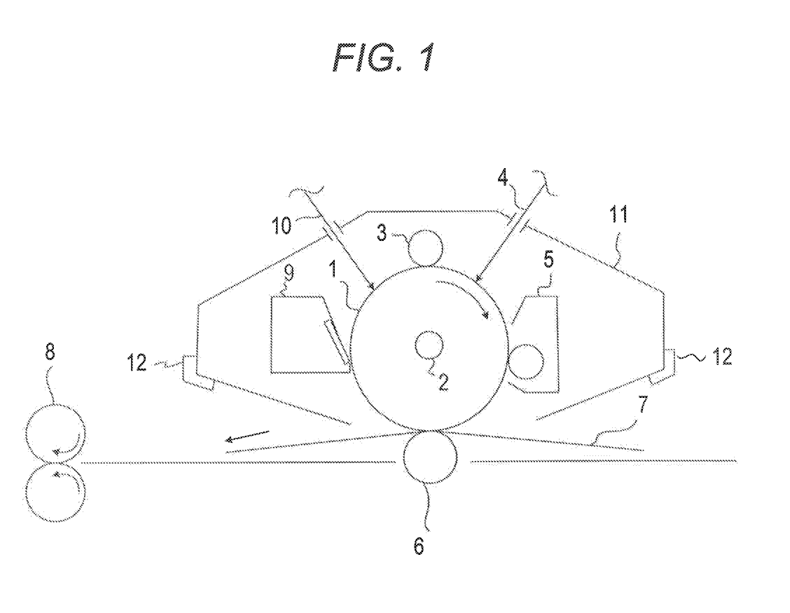

FIG. 1 is a view illustrating one example of a schematic configuration of an electrophotographic apparatus provided with a process cartridge including the electrophotographic photosensitive member of the present invention.

In FIG. 1, a 1 is a cylindrical (drum-shaped) electrophotographic photosensitive member, is rotatably driven at a predetermined peripheral speed (process speed) about a shaft 2 in the arrow direction.

The surface of the electrophotographic photosensitive member 1 is charged to a predetermined positive or negative potential by a charging unit 3 in the course of rotation. Next, the surface charged of the electrophotographic photosensitive member 1 is irradiated with image exposing light 4 from an image exposing unit (not illustrated), and an electrostatic latent image is formed according to image information intended. The image exposing light 4 is light intensity-modulated according to a time-series electric digital image signal of image information intended, the light being output from an image exposing unit such as a slit exposing unit or a laser beam scanning exposure unit.

The electrostatic latent image formed on the surface of the electrophotographic photosensitive member 1 is developed (regularly developed or reversely developed) by a toner accommodated in a developing unit 5, and a toner mage is formed on the surface of the electrophotographic photosensitive member 1. The toner image formed on the surface of the electrophotographic photosensitive member 1 is transferred on a transfer material 7 by a transfer unit 6. A bias voltage having a reverse polarity to the charge retained by the toner is here applied to the transfer unit from a bias power source (not illustrated). When the transfer material 7 is paper, the transfer material 7 is taken out from a paper-feeding unit (not illustrated) and fed between the electrophotographic photosensitive member 1 and the transfer unit 6 in synchronization with the rotation of the electrophotographic photosensitive member 1.

The transfer material 7, on which the toner image is transferred from the electrophotographic photosensitive member 1, is separated from the surface of the electrophotographic photosensitive member 1, conveyed to an image-fixing unit 8, subjected to a fixing treatment of the toner image and discharged as an image forming product (print, copy) outside the electrophotographic apparatus.

The surface of the electrophotographic photosensitive member 1, from which the toner image is transferred to the transfer material 7, is cleaned by removal of an adhering substance such as a toner (transfer residual toner) by a cleaning unit 9. A cleaner-less system has also been recently developed, and the transfer residual toner can also be directly removed by a developing machine or the like. Furthermore, the surface of the electrophotographic photosensitive member 1 is subjected to an antistatic treatment by pre-exposing light 10 from a pre-exposing unit (not illustrated), and thereafter repeatedly used for image formation. Herein, when the charging unit 3 is a contact charging unit using a charging roller or the like, the pre-exposing unit is not necessarily needed.

In the present invention, a plurality of constituent elements among the constituent elements such as the electrophotographic photosensitive member 1, the charging unit 3 and the cleaning unit 9 may be accommodated in a container to be integrally supported to form a process cartridge. The process cartridge can be then configured to be detachably attachable to the main body of the electrophotographic apparatus. For example, at least one selected from the charging unit 3, the developing unit 5 and the cleaning unit 9 is integrally supported together with the electrophotographic photosensitive member 1 to form a cartridge, and the cartridge can be formed into a process cartridge 11 detachably attachable to the main body of the electrophotographic apparatus by using a guide unit such as a rail of the main body of the electrophotographic apparatus.

When the electrophotographic apparatus is a copier or a printer, the image exposing light 4 may be light reflected or transmitted from an original manuscript. Alternatively, the image exposing light 4 may be light radiated by reading of the original manuscript by a sensor for conversion to signals, and scanning of a laser beam, driving of an LED array, driving of a liquid crystal shutter array, or the like performed according to the signals.

The speed of the electrophotographic process in the present invention, with respect to the charging, exposing, developing, transferring and the like, is expressed as a cycle time. The cycle time means the time (sec) required for one cycle of the electrophotographic process in the electrophotographic photosensitive member. In the present invention, the cycle time is set to be 0.4 seconds or less in order to address recent speed-up.

The electrophotographic photosensitive member 1 of the present invention can also be widely applied in the electrophotographic application field such as a laser beam printer, a CRT printer, an LED printer, FAX, a liquid crystal printer and laser plate making.

### EXAMPLES

Hereinafter, the present invention is described with reference to specific Examples in more detail. “Part(s)” described below means “part(s) by mass”. The present invention, however, is not limited thereto. Herein, the thickness of each of the layers of the electrophotographic photosensitive member in each of Examples and Comparative Examples was determined by an eddy current type film thickness meter (Fischerscope manufactured by Fischer Instruments), or determined from the mass per unit area in terms of specific gravity.

### Synthesis Example 1

Under a nitrogen flow atmosphere, 5.46 parts of phthalonitrile and 45 parts of a-chloronaphthalene were loaded to a reaction vessel and thereafter heated to a temperature of 30° C., and thereafter the temperature was kept. Next, 3.75 parts of gallium trichloride was loaded thereto at the temperature (30° C.). The moisture value of the mixed liquid in loading was 150 ppm. Thereafter, the temperature was raised to 200° C. Next, under a nitrogen flow atmosphere, the resultant was subjected to a reaction at a temperature of 200° C. for 4.5 hours and thereafter cooled, and when the temperature reached 150° C., the resultant was filtered to provide a product. The resulting product by filtration was dispersed in and washed with N,N-dimethylformamide at a temperature of 140° C. for 2 hours, and thereafter the resultant was filtered. The resulting product by filtration was washed with methanol, and thereafter dried to provide 4.65 parts of a chlorogallium phthalocyanine pigment (yield: 71%).

### Synthesis Example 2

The chlorogallium phthalocyanine pigment obtained in Synthesis Example 1 (4.65 parts) was dissolved in 139.5 parts of concentrated sulfuric acid at a temperature of 10° C., the resulting solution was dropped in 620 parts of ice water under stirring, for reprecipitation, and filtered using a filter press. The resulting wet cake (product by filtration) was dispersed in and washed with 2% ammonia water, and thereafter filtered using a filter press. Next, the resulting wet cake (product by filtration) was dispersed in and washed with ion-exchange water, thereafter filtration using a filter press was repeated three times, and thereafter a hydroxygallium phthalocyanine pigment (hydrous hydroxygallium phthalocyanine pigment) having a solid content of 23% was obtained (acid pasting treatment).

Next, 6.6 kg of the resulting hydroxygallium phthalocyanine pigment (hydrous hydroxygallium phthalocyanine pigment) was dried using a Hyper-Dry dryer (product name: HD-06R, frequency (oscillation frequency): 2455 MHz±15 MHz, manufactured by Biocon (Japan) Ltd.) as follows.

The resulting hydroxygallium phthalocyanine pigment was placed on a dedicated circular plastic tray as a mass taken out from the filter press (the thickness of the hydrous cake: 4 cm or less), and far infrared rays were set to OFF and the temperature of the inner wall of the dryer was set to 50° C. Then, when irradiation with a microwave was performed, a vacuum pump and a leak valve were adjusted to adjust the degree of vacuum to 4.0 to 10.0 kPa.

First, in a first step, the hydroxygallium phthalocyanine pigment was irradiated with a microwave of 4.8 kW for 50 minutes. Next, the microwave was then turned off once and the leak valve was closed to provide a high vacuum atmosphere of 2 kPa or less. The solid content of the hydroxygallium phthalocyanine pigment here was 88%.

In a second step, the leak valve was adjusted to adjust the degree of vacuum (the pressure in the dryer) to the setting value (4.0 to 10.0 kPa), thereafter the hydroxygallium phthalocyanine pigment was irradiated with a microwave of 1.2 kW for 5 minutes, and the microwave was turned off once and the leak valve was closed to provide a high vacuum of 2 kPa or less. The second step was repeated one more time (twice in total). The solid content of the hydroxygallium phthalocyanine pigment here was 98%.

In a third step, irradiation with a microwave was performed in the same manner as in the second step except that the microwave in the second step was changed from 1.2 kW to 0.8 kW. The third step was repeated one more time (twice in total).

In a fourth step, the leak valve was adjusted to adjust the degree of vacuum (the pressure in the dryer) to the setting value (4.0 to 10.0 kPa), thereafter the hydroxygallium phthalocyanine pigment was irradiated with a microwave of 0.4 kW for 3 minutes, and the microwave was turned off once and the leak valve was closed to provide a high vacuum of 2 kPa or less. The fourth step was further repeated seven times (8 times in total).

As described above, 1.52 kg of a hydroxygallium phthalocyanine pigment having a water content of 1% or less was obtained in 3 hours in total.

### Example 1-1

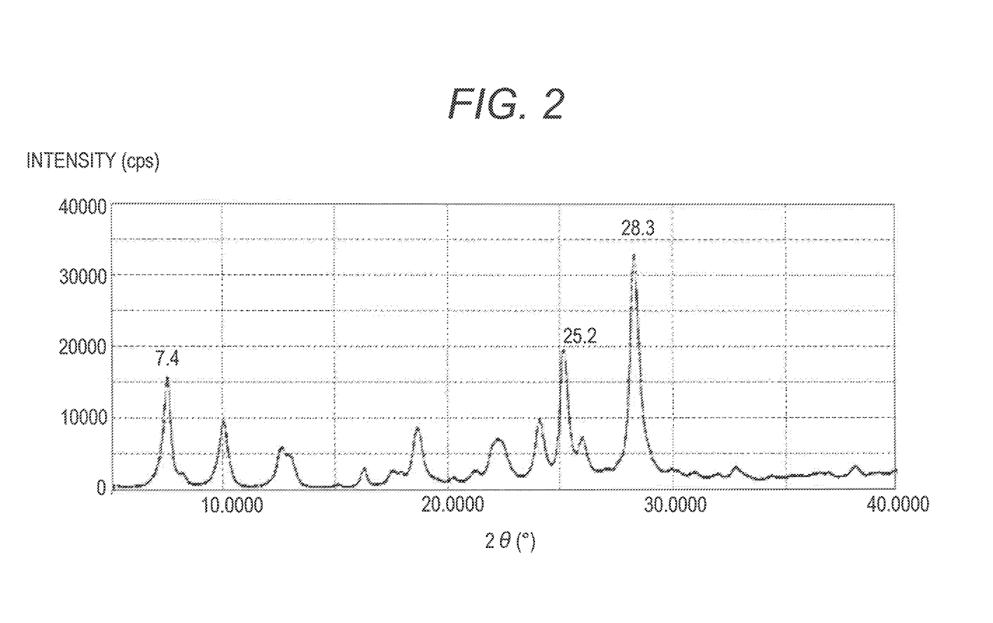

The hydroxygallium phthalocyanine pigment (0.5 parts) obtained in Synthesis Example 2 and 10 parts of N,N-dimethylformamide were subjected to a wet milling treatment by a ball mill together with 20 parts of glass beads having a diameter of 0.8 mm under conditions of room temperature (23° C.) and 120 rpm for 400 hours. A gallium phthalocyanine crystal was taken out from such a dispersion by using N,N-dimethylformamide, and filtration was conducted and a filter was sufficiently washed with tetrahydrofuran. A product taken out by filtration was dried under vacuum to provide 0.45 parts of a hydroxygallium phthalocyanine crystal. The powder X-ray diffraction diagram of the resulting crystal is illustrated in FIG. 2. It was confirmed by 1H-NMR measurement that the content of N,N-dimethylformamide in the hydroxygallium phthalocyanine crystal obtained in the present Example was 1.4% by mass in terms of the ratio of proton. N,N-dimethylformamide is compatible with tetrahydrofuran, and thus N,N-dimethylformamide is found to be contained in the crystal.

### Example 1-2

Except that the wet milling treatment time was changed from 400 hours to 2000 hours in Example 1-1, the same treatment as in Example 1-1 was performed to provide 0.43 parts of a hydroxygallium phthalocyanine crystal. The powder X-ray diffraction of the resulting hydroxygallium phthalocyanine crystal was the same as the powder X-ray diffraction illustrated in FIG. 2.

It was confirmed by ¹H-NMR measurement that the content of N,N-dimethylformamide phthalocyanine in the hydroxygallium phthalocyanine crystal obtained in the present Example was 0.8% by mass in terms of the ratio of proton.

### Example 1-3

Except that 10 parts of N,N-dimethylformamide was changed to 10 parts of dimethylsulfoxide and the wet milling treatment time was changed from 400 hours to 300 hours in Example 1-1, the same treatment as in Example 1-1 was performed to provide 0.41 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of dimethylsulfoxide in the hydroxygallium phthalocyanine crystal obtained in the present Example was 1.3% by mass in terms of the ratio of proton.

### Example 1-4

Except that the wet milling treatment time was changed from 300 hours to 2000 hours in Example 1-3, the same treatment as in Example 1-3 was performed to provide 0.39 parts of a hydroxygallium phthalocyanine crystal. The powder X-ray diffraction of the resulting hydroxygallium phthalocyanine crystal was the same as the powder X-ray diffraction illustrated in FIG. 2.

It was confirmed by 1H-NMR measurement that the content of dimethylsulfoxide in the hydroxygallium phthalocyanine crystal obtained in the present Example was 0.7% by mass in terms of the ratio of proton.

### Example 1-5

Except that 10 parts of N,N-dimethylformamide was changed to 10 parts of N-methylformamide and the wet milling treatment time was changed from 400 hours to 200 hours in Example 1-1, the same treatment was performed as in Example 1-1 to provide 0.45 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of N-methylformamide in the hydroxygallium phthalocyanine crystal obtained in the present Example was 1.2% by mass in terms of the ratio of proton.

### Example 1-6

Except that the wet milling treatment time was changed from 200 hours to 1000 hours in Example 1-5, the same treatment as in Example 1-5 was performed to provide 0.43 parts of a hydroxygallium phthalocyanine crystal. The powder X-ray diffraction of the resulting hydroxygallium phthalocyanine crystal was the same as the powder X-ray diffraction illustrated in FIG. 2.

It was confirmed by ¹H-NMR measurement that the content of N-methylformamide in the hydroxygallium phthalocyanine crystal obtained in the present Example was 0.5% by mass in terms of the ratio of proton.

### Example 1-7

Except that 10 parts of N,N-dimethylformamide was changed to 10 parts of N-n-propylformamide and the milling treatment time was changed from 400 hours to 500 hours in Example 1-1, the same treatment as in Example 1-1 was performed to provide 0.45 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of N-n-propylformamide in the hydroxygallium phthalocyanine crystal obtained in the present Example was 1.5% by mass in terms of the ratio of proton.

### Example 1-8

Except that the wet milling treatment time was changed from 500 hours to 1000 hours in Example 1-7, the same treatment as in Example 1-7 was performed to provide 0.43 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of N-n-propylformamide in the hydroxygallium phthalocyanine crystal obtained in the present Example was 0.9% by mass in terms of the ratio of proton.

### Example 1-9

Except that 10 parts of N,N-dimethylformamide was changed to 10 parts of N-vinylformamide and the wet milling treatment time was changed from 400 hours to 600 hours in Example 1-1, the same treatment as in Example 1-1 was performed to provide 0.45 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of N-vinylformamide in the hydroxygallium phthalocyanine crystal obtained in the present Example was 1.5% by mass in terms of the ratio of proton.

### Example 1-10

Except that the milling treatment time was changed from 600 hours to 1000 hours in Example 1-9, the same treatment as in Example 1-9 was performed to provide 0.45 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of N-vinylformamide in the hydroxygallium phthalocyanine crystal obtained in the present Example was 1.0% by mass in terms of the ratio of proton.

### Example 1-11

Except that 10 parts of N,N-dimethylformamide was changed to 10 parts of N-methyl-2-pyrrolidone and the milling treatment time was changed from 400 hours to 800 hours in Example 1-1, the same treatment as in Example 1-1 was performed to provide 0.44 parts of a hydroxygallium phthalocyanine crystal. The powder X-ray diffraction of the resulting hydroxygallium phthalocyanine crystal was the same as the powder X-ray diffraction illustrated in FIG. 2. It was confirmed by ¹H-NMR measurement that the content of N-methyl-2-pyrrolidone in the hydroxygallium phthalocyanine crystal obtained in the present Example was 1.4% by mass in terms of the ratio of proton.

### Example 1-12

The chlorogallium phthalocyanine pigment (0.5 parts) obtained in Synthesis Example 1 and 10 parts of N,N-dimethylformamide were subjected to a wet milling treatment by a magnetic stirrer at room temperature (23° C.) for 4 hours.

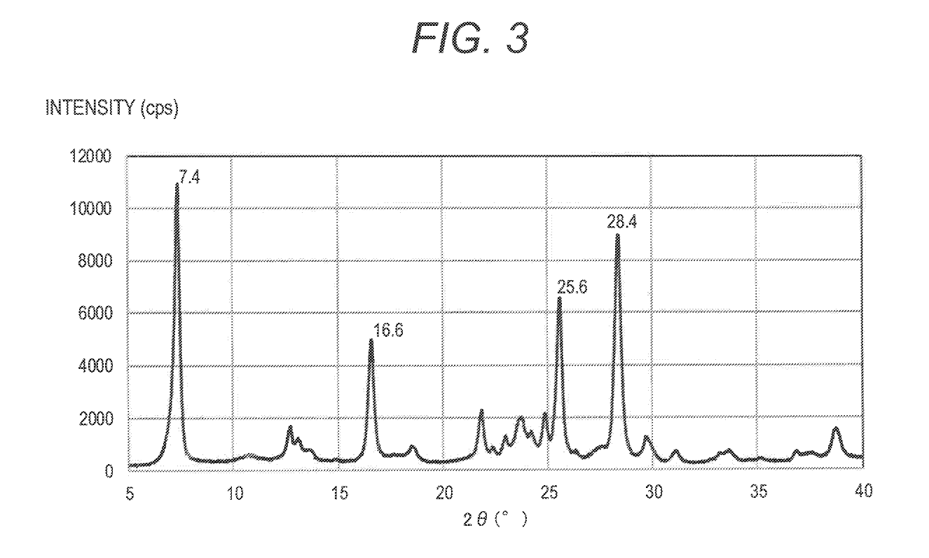

A chlorogallium phthalocyanine crystal was taken out from the resulting dispersion by using N,N-dimethylformamide, and filtration was conducted and a filter was sufficiently washed with tetrahydrofuran. A product taken out by filtration was dried under vacuum to provide 0.47 parts of a chlorogallium phthalocyanine crystal. The powder X-ray diffraction diagram of the resulting crystal is illustrated in FIG. 3. It was confirmed by ¹H-NMR measurement that the content of N,N-dimethylformamide in the chlorogallium phthalocyanine crystal obtained in present Example was 0.7% by mass in terms of the ratio of proton.

### Example 1-13

Except that, in Example 1-12, 10 parts of N,N-dimethylformamide was changed to 10 parts of N-methylformamide and the wet milling treatment time was changed from 4 hours to 24 hours, the same treatment as in Example 1-12 was performed to provide 0.45 parts of a chlorogallium phthalocyanine crystal. The powder X-ray diffraction of the resulting chlorogallium phthalocyanine crystal was the same as the powder X-ray diffraction illustrated in FIG. 3. It was confirmed by ¹H-NMR measurement that the content of N-methylformamide in the chlorogallium phthalocyanine crystal obtained in the present Example was 0.4% by mass in terms of the ratio of proton.

### Comparative Example 1-1

Except that the wet milling treatment time was changed from 400 hours to 48 hours in Example 1-1, the same treatment as in Example 1-1 was performed to provide 0.46 parts of a hydroxygallium phthalocyanine crystal. It was confirmed by 1H-NMR measurement that the content of N,N-dimethylformamide in the hydroxygallium phthalocyanine crystal obtained in the present Comparative Example was 2.1% by mass in terms of the ratio of proton.

### Comparative Example 1-2

Except that the wet milling treatment time was changed from 300 hours to 48 hours in Example 1-3, the same treatment as in Example 1-3 was performed to provide 0.41 parts of a hydroxygallium phthalocyanine crystal. It was confirmed by ¹H-NMR measurement that the content of dimethylsulfoxide in the hydroxygallium phthalocyanine crystal obtained in the present Comparative Example was 2.1% by mass in terms of the ratio of proton.

### Comparative Example 1-3

Except that the wet milling treatment time was changed from 800 hours to 400 hours in Example 1-11, the same treatment as in Example 1-11 was performed to provide 0.43 parts of a hydroxygallium phthalocyanine crystal. It was confirmed by ¹H-NMR measurement that the content of N-methyl-2-pyrrolidone in the hydroxygallium phthalocyanine crystal obtained in the present Comparative Example was 1.6% by mass in terms of the ratio of proton.

### Example 2-1

Sixty parts of a barium sulfate particle covered with tin oxide (product name: Pastolan PC1, produced by Mitsui Mining & Smelting Co., Ltd.), 15 parts of a titanium oxide particle (product name: TITANIX JR, produced by Tayca), 43 parts of a resol type phenol resin (product name: Phenolite J-325, produced by DIC Corporation, solid content: 70% by mass), 0.015 parts of a silicone oil (product name: SH28PA, produced by Dow Corning Toray Silicone Co., Ltd.), 3.6 parts of a silicone resin (product name: Tospearl 120, produced by Toshiba Silicone Co., Ltd.), 50 parts of 2-methoxy-1-propanol and 50 parts of methanol were subjected to a dispersing treatment by a ball mill for hours to thereby prepare a coating liquid for an electro-conductive layer.

An alumina cylinder as the support was dip-coated with the coating liquid for an electro-conductive layer, and the resulting coating film was dried at 140° C. for 30 minutes to thereby form an electro-conductive layer having a thickness of 15 μm.

Next, 10 parts of a copolymerized nylon resin (product name: Amilan CM8000, produced by Toray Industries Inc.) and 30 parts of a methoxymethylated 6 nylon resin (product name: Tresin EF-30T, produced by Teikoku Chemical Industries Co., Ltd.) were dissolved in a mixed solvent of 400 parts of methanol/200 parts of n-butanol to thereby prepare a coating liquid for an undercoat layer.

The electro-conductive layer was dip-coated with the coating liquid for an undercoat layer, and the resulting coating film was dried to thereby form an undercoat layer having a thickness of 0.7 μm.

Next, 10 parts of the hydroxygallium phthalocyanine crystal (charge generating material) obtained in Example 1-1, 5 parts of polyvinyl butyral (product name: S-LEC BX-1, produced by Sekisui Chemical Co., Ltd.), 200 parts of cyclohexanone and 400 parts of glass beads having a diameter of 1 mm were loaded in a sand mill, and subjected to a dispersing treatment for 4 hours. One hundred parts of cyclohexanone and 300 parts of ethyl acetate were added to the dispersion and diluted to thereby prepare a coating liquid for a charge generating layer.

The undercoat layer was dip-coated with the coating liquid for a charge generating layer, and the resulting coating film was dried at 100° C. for 10 minutes to thereby form a charge generating layer having a thickness of 0.22 μm.

Next, 6 parts of a compound (charge transporting material) represented by the following formula (CTM-1), 3 parts of a compound (charge transporting material) represented by the following formula (CTM-2), 1 part of a resin (PC-1) having a siloxane structure, 9 parts of a resin (binder resin) having a structural unit represented by the formula (B-1), 35 parts of toluene, 25 parts of dimethoxymethane and 15 parts of methyl benzoate (compound (Q)) were mixed to prepare a solution, thereby providing a coating liquid for a charge transporting layer. The configuration of the coating liquid for a charge transporting layer is partially shown in Table 4.

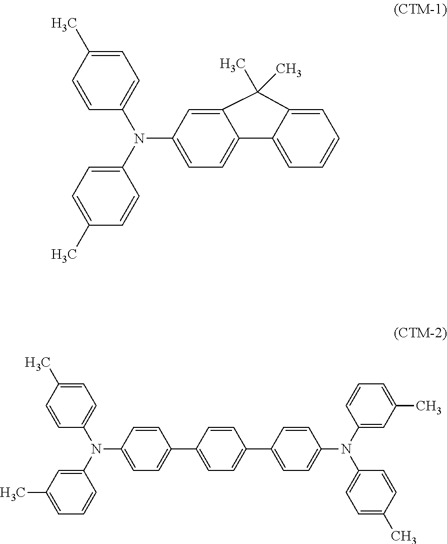

The charge generating layer was dip-coated with the coating liquid for a charge transporting layer, and the resulting coating film was dried at 125° C. for 45 minutes to thereby form a charge transporting layer having a thickness of 23.5 μm.

The electrophotographic photosensitive member of the present Example was thus produced. The content of the compound (Q) in the charge transporting layer was measured using the above gas chromatography, and as a result, was 1.2% by mass.

Next, the electrophotographic photosensitive member produced was subjected to photomemory evaluation on an image output after repeated use. For the evaluation apparatus, a laser beam printer (P4510) manufactured by Hewlett-Packard Development Company, L.P. was used. Herein, a drive system and a control system were altered so that the cycle time of the main body of the laser beam printer was 0.23 seconds.

First, the electrophotographic photosensitive member was mounted to a process cartridge of the laser beam printer, and was placed under an environment of a temperature of 20° C. and a relative humidity of 10%. In the initial image evaluation, halftone and alphabet letter image was output. Subsequently, a halftone image was output for 10,000 sheets. When a developing agent was exhausted halfway, a developing agent was refilled in the process cartridge, and outputting of the image was continued. Thereafter, the electrophotographic photosensitive member was taken out from the process cartridge, the surface of the electrophotographic photosensitive member was partially subjected to light-shielding in the circumferential direction, and a region thereof not subjected to light-shielding was irradiated with light of 1700 lux by use of a fluorescent lamp for 5 minutes. The electrophotographic photosensitive member was mounted to another process cartridge not used, and a halftone image was output. With respect to the halftone image, the difference in density (irregularities) between the region subjected to light-shielding and the region not subjected to light-shielding was rated by ranking.

The rating criteria of image ranking are shown below.
A: no difference in density could be confirmed.
B: the difference in density was extremely slightly confirmed.
C: the difference in density was slightly confirmed.
D: the difference in density was confirmed, but the boundary line between the region irradiated and the region not irradiated was not sharp.
E: a clear difference in density was confirmed, and the boundary line between the region irradiated and the region not irradiated was partially sharp.
F: a clear difference in density was confirmed, and the boundary line between the region irradiated and the region not irradiated was entirely sharp.

In evaluation of cleaning property, the presences of streaks and character loss due to cleaning failure were confirmed from the initial halftone and alphabet letter image. The rating criteria of image ranking are shown below.
A: neither streaks nor character loss could be confirmed.
B: Either extremely slight streaks or character loss was confirmed.
C: slight streaks or character loss was confirmed.
D: clear streaks and character loss were confirmed on a partial region of the image.
E: clear streaks and character loss were confirmed on the entire of the image.

The evaluation results are shown in Table 5.

### Example 2-2

Except that, in Example 2-1, the resin having a siloxane structure and the compound (Q) in preparation of the coating liquid for a charge transporting layer were changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.4% by mass. The evaluation results are shown in Table 5.

### Example 2-3

Except that, in Example 2-1, the hydroxygallium phthalocyanine crystal in preparation of the coating liquid for a charge generating layer was changed to the hydroxygallium phthalocyanine crystal obtained in Example 1-2, and furthermore the resin having a siloxane structure and the compound (Q) in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.5% by mass. The evaluation results are shown in Table 5.

### Example 2-4

Except that, in Example 2-1, the hydroxygallium phthalocyanine crystal in preparation of the coating liquid for a charge generating layer was changed to the hydroxygallium phthalocyanine crystal obtained in Example 1-2, and furthermore the resin having a siloxane structure and the compound (Q) in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 0.8% by mass. The evaluation results are shown in Table 5.

### Example 2-5

Except that, in Example 2-1, the hydroxygallium phthalocyanine crystal in preparation of the coating liquid for a charge generating layer was changed to the hydroxygallium phthalocyanine crystal obtained in Example 1-3 and the resin having a siloxane structure, the binder resin and the compound (Q) in preparation of the coating liquid for a charge transporting layer were changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.0% by mass. The evaluation results are shown in Table 5.

### Example 2-6

Except that, in Example 2-1, the hydroxygallium phthalocyanine crystal in preparation of the coating liquid for a charge generating layer was changed to the hydroxygallium phthalocyanine crystal obtained in Example 1-3, the resin having a siloxane structure, the binder resin and the compound (Q) in preparation of the coating liquid for a charge transporting layer were changed to a configuration shown in Table 4, and 35 parts of toluene and 15 parts of methyl benzoate (compound (Q)) in preparation of the coating liquid for a charge transporting layer were changed to 40 parts of toluene and 10 parts of propylene carbonate (compound (Q)), respectively, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.8% by mass. The evaluation results are shown in Table 5.

### Example 2-7

Except that, in Example 2-1, the hydroxygallium phthalocyanine crystal in preparation of the coating liquid for a charge generating layer was changed to the hydroxygallium phthalocyanine crystal obtained in Example 1-4, the resin having a siloxane structure, the binder resin and the compound (Q) in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.3% by mass. The evaluation results are shown in Table 5.

### Example 2-8

Except that, in Example 2-1, the hydroxygallium phthalocyanine crystal in preparation of the coating liquid for a charge generating layer was changed to the hydroxygallium phthalocyanine crystal obtained in Example 1-4, the resin having a siloxane structure and the binder resin in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.2% by mass. The evaluation results are shown in Table 5.

### Example 2-9

Except that, in Example 2-1, the hydroxygallium phthalocyanine crystal in preparation of the coating liquid for a charge generating layer was changed to the hydroxygallium phthalocyanine crystal obtained in Example 1-5 and the resin having a siloxane structure in preparation of the coating liquid for a charge transporting layer was changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.1% by mass. The evaluation results are shown in Table 5.

### Example 2-10

Except that, in Example 2-1, the hydroxygallium phthalocyanine crystal in preparation of the coating liquid for a charge generating layer was changed to the hydroxygallium phthalocyanine crystal obtained in Example 1-5 and the resin having a siloxane structure in preparation of the coating liquid for a charge transporting layer was changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.2% by mass. The evaluation results are shown in Table 5.

### Example 2-11

Except that, in Example 2-1, the hydroxygallium phthalocyanine crystal in preparation of the coating liquid for a charge generating layer was changed to the hydroxygallium phthalocyanine crystal obtained in Example 1-6, the resin having a siloxane structure in preparation of the coating liquid for a charge transporting layer was changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.3% by mass. The evaluation results are shown in Table 5.

### Example 2-12

Except that, in Example 2-1, the hydroxygallium phthalocyanine crystal in preparation of the coating liquid for a charge generating layer was changed to the hydroxygallium phthalocyanine crystal obtained in Example 1-6, the resin having a siloxane structure in preparation of the coating liquid for a charge transporting layer was changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.3% by mass. The evaluation results are shown in Table 5.

### Example 2-13

Except that, in Example 2-1, the hydroxygallium phthalocyanine crystal in preparation of the coating liquid for a charge generating layer was changed to the hydroxygallium phthalocyanine crystal obtained in Example 1-7 and the resin having a siloxane structure in preparation of the coating liquid for a charge transporting layer was changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.2% by mass. The evaluation results are shown in Table 5.

### Example 2-14

Except that, in Example 2-1, the hydroxygallium phthalocyanine crystal in preparation of the coating liquid for a charge generating layer was changed to the hydroxygallium phthalocyanine crystal obtained in Example 1-7 and the resin having a siloxane structure in preparation of the coating liquid for a charge transporting layer was changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.3% by mass. The evaluation results are shown in Table 5.

### Example 2-15

Except that, in Example 2-1, the hydroxygallium phthalocyanine crystal in preparation of the coating liquid for a charge generating layer was changed to the hydroxygallium phthalocyanine crystal obtained in Example 1-8, the resin having a siloxane structure and the binder resin in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.2% by mass. The evaluation results are shown in Table 5.

### Example 2-16

Except that, in Example 2-1, the hydroxygallium phthalocyanine crystal in preparation of the coating liquid for a charge generating layer was changed to the hydroxygallium phthalocyanine crystal obtained in Example 1-8, the resin having a siloxane structure and the binder resin in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.3% by mass. The evaluation results are shown in Table 5.

### Example 2-17

Except that, in Example 2-1, the hydroxygallium phthalocyanine crystal in preparation of the coating liquid for a charge generating layer was changed to the hydroxygallium phthalocyanine crystal obtained in Example 1-9 and the resin having a siloxane structure and the binder resin in preparation of the coating liquid for a charge transporting layer were changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.3% by mass. The evaluation results are shown in Table 5.

### Example 2-18

Except that, in Example 2-1, the hydroxygallium phthalocyanine crystal in preparation of the coating liquid for a charge generating layer was changed to the hydroxygallium phthalocyanine crystal obtained in Example 1-9 and the resin having a siloxane structure and the binder resin in preparation of the coating liquid for a charge transporting layer were changed to a configuration shown in Table 4, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.1% by mass. The evaluation results are shown in Table 5.

### Example 2-19

Except that, in Example 2-1, the hydroxygallium phthalocyanine crystal in preparation of the coating liquid for a charge generating layer was changed to the hydroxygallium phthalocyanine crystal obtained in Example 1-10, the resin having a siloxane structure and the binder resin in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.2% by mass. The evaluation results are shown in Table 5.

### Example 2-20

Except that, in Example 2-1, the hydroxygallium phthalocyanine crystal in preparation of the coating liquid for a charge generating layer was changed to the hydroxygallium phthalocyanine crystal obtained in Example 1-10, the resin having a siloxane structure and the binder resin in preparation of the coating liquid for a charge transporting layer were changed to a configuration shown in Table 4 and toluene in preparation of the coating liquid for a charge transporting layer was changed to o-xylene, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 1.2% by mass. The evaluation results are shown in Table 5.

### Example 2-21

Except that, in Example 2-1, the hydroxygallium phthalocyanine crystal in preparation of the coating liquid for a charge generating layer was changed to the hydroxygallium phthalocyanine crystal obtained in Example 1-11, the resin having a siloxane structure and the binder resin in preparation of the coating liquid for a charge transporting layer were changed to a configuration shown in Table 4, and 35 parts of toluene and 15 parts of methyl benzoate (compound (Q)) in preparation of the coating liquid for a charge transporting layer were changed to 45 parts of o-xylene and 5 parts of methyl benzoate (compound (Q)), respectively, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 0.5% by mass. The evaluation results are shown in Table 5.

### Example 2-22

Except that, in Example 2-1, the hydroxygallium phthalocyanine crystal in preparation of the coating liquid for a charge generating layer was changed to the hydroxygallium phthalocyanine crystal obtained in Example 1-11, the resin having a siloxane structure and the binder resin in preparation of the coating liquid for a charge transporting layer were changed to a configuration shown in Table 4, and 35 parts of toluene and 15 parts of methyl benzoate (compound (Q)) in preparation of the coating liquid for a charge transporting layer were changed to 48 parts of o-xylene and 2 parts of methyl benzoate (compound (Q)), respectively, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 0.03% by mass. The evaluation results are shown in Table 5.

### Example 2-23

Except that, in Example 2-1, the hydroxygallium phthalocyanine crystal in preparation of the coating liquid for a charge generating layer was changed to the chlorogallium phthalocyanine crystal obtained in Example 1-12, the resin having a siloxane structure and the binder resin in preparation of the coating liquid for a charge transporting layer were changed to a configuration shown in Table 4, and 35 parts of toluene and 15 parts of methyl benzoate (compound (Q)) in preparation of the coating liquid for a charge transporting layer were changed to 30 parts of o-xylene and 20 parts of ethyl benzoate (compound (Q)), respectively, the same manner as in Example 2-1 was performed to produce an electrophotographic photosensitive member of the present Example, and the electrophotographic photosensitive member was evaluated. The content of the compound (Q) in the charge transporting layer was measured using the above gas chromatography, and as a result, was 2.0% by mass. The evaluation results are shown in Table 5.

### Example 2-24

Except that, in Example 2-1, the hydroxygallium phthalocyanine crystal in preparation of the coating liquid for a charge generating layer was changed to the chlorogallium phthalocyanine crystal obtained in Example 1-13, the resin having a siloxane structure and the binder resin in preparation of the coating liquid for a charge transporting layer were changed to a configuration shown in Table 4 and the compound (Q) was not used for the charge transporting layer, the same manner as in Example 2-1 was performed to produce an electrophotographic photosensitive member of the present Example, and the electrophotographic photosensitive member was evaluated. The evaluation results are shown in Table 5.

### Comparative Example 2-1

Except that, in Example 2-1, the hydroxygallium phthalocyanine crystal in preparation of the coating liquid for a charge generating layer was changed to the hydroxygallium phthalocyanine crystal obtained in Comparative Example 1-1, the resin having a siloxane structure and the binder resin in preparation of the coating liquid for a charge transporting layer were changed to a configuration shown in Table 4, methyl benzoate (compound (Q)) was not used in preparation of the coating liquid for a charge transporting layer, 25 parts of dimethoxymethane was changed to 40 parts of tetrahydrofuran and 5 parts of a dimethylsilicone oil (product name: KF-96-100cs, produced by Shin-Etsu Chemical Co., Ltd.) was added to the coating liquid for a charge transporting layer, the same manner as in Example 2-1 was performed to produce an electrophotographic photosensitive member of the present Comparative Example, and the electrophotographic photosensitive member was evaluated. The evaluation results are shown in Table 5.

### Comparative Example 2-2

Except that, in Example 2-1, the hydroxygallium phthalocyanine crystal in preparation of the coating liquid for a charge generating layer was changed to the hydroxygallium phthalocyanine crystal obtained in Comparative Example 1-2, the resin having a siloxane structure and the binder resin in preparation of the coating liquid for a charge transporting layer were changed to a configuration shown in Table 4, methyl benzoate (compound (Q)) was not used in preparation of the coating liquid for a charge transporting layer and 25 parts of dimethoxymethane was changed to 40 parts of tetrahydrofuran, the same manner as in Example 2-1 was performed to produce an electrophotographic photosensitive member of the present Comparative Example, and the electrophotographic photosensitive member was evaluated. The evaluation results are shown in Table 5.

### Comparative Example 2-3

Except that, in Example 2-1, the hydroxygallium phthalocyanine crystal in preparation of the coating liquid for a charge generating layer was changed to the hydroxygallium phthalocyanine crystal obtained in Comparative Example 1-3, the resin having a siloxane structure and the binder resin in preparation of the coating liquid for a charge transporting layer were changed to a configuration shown in Table 4, methyl benzoate (compound (Q)) was not used in preparation of the coating liquid for a charge transporting layer and 25 parts of dimethoxymethane was changed to 40 parts of tetrahydrofuran, the same manner as in Example 2-1 was performed to produce an electrophotographic photosensitive member of the present Comparative Example, and the electrophotographic photosensitive member was evaluated. The evaluation results are shown in Table 5.

### Comparative Example 2-4

Except that, in Example 2-1, the hydroxygallium phthalocyanine crystal in preparation of the coating liquid for a charge generating layer was changed to the hydroxygallium phthalocyanine crystal obtained in Example 1-11, the resin having a siloxane structure and the binder resin in preparation of the coating liquid for a charge transporting layer were changed to a configuration shown in Table 4, methyl benzoate (compound (Q)) was not used in preparation of the coating liquid for a charge transporting layer and 25 parts of dimethoxymethane was changed to 40 parts of tetrahydrofuran, the same manner as in Example 2-1 was performed to produce an electrophotographic photosensitive member of the present Comparative Example, and the electrophotographic photosensitive member was evaluated. The evaluation results are shown in Table 5.

TABLE 4

| | | Content of resin | | |
|---|---|---|---|---|
| | Resin | having siloxane | | |
| | having | structure (% by | | |
| | siloxane | mass, based on | Structural unit of | |
| | structure | total resin) | binder resin | Compound (Q) |
| Example 2-1 | PC-1 | 10 | B-1 | Methyl benzoate |
| Example 2-2 | PC-2 | 10 | B-1 | Ethyl benzoate |
| Example 2-3 | PC-3 | 10 | B-1 | Benzyl acetate |
| Example 2-4 | PC-4 | 10 | B-1 | Ethyl 3-ethoxypropionate |
| Example 2-5 | PC-5 | 10 | B-22 + B-23(5/5) | Diethylene glycol ethyl |
| | | | | methyl ether |
| Example 2-6 | PC-6 | 20 | B-22 + B-23(5/5) | Propylene carbonate |
| Example 2-7 | PC-7 | 40 | B-22 + B-23(5/5) | γ-Butyrolactone |
| Example 2-8 | PC-8 | 50 | B-22 + B-23(5/5) | Methyl benzoate |
| Example 2-9 | PC-9 | 10 | B-1 | Methyl benzoate |
| Example 2-10 | PC-10 | 10 | B-1 | Methyl benzoate |
| Example 2-11 | PC-11 | 10 | B-1 | Methyl benzoate |
| Example 2-12 | PC-12 | 10 | B-1 | Methyl benzoate |
| Example 2-13 | PC-13 | 10 | B-1 | Methyl benzoate |
| Example 2-14 | PE-1 | 10 | B-1 | Methyl benzoate |
| Example 2-15 | PE-2 | 10 | B-13 + B-14(5/5) | Methyl benzoate |
| Example 2-16 | PE-3 | 10 | B-13 + B-14(5/5) | Methyl benzoate |
| Example 2-17 | PE-4 | 10 | B-13 + B-14(5/5) | Methyl benzoate |
| Example 2-18 | PE-5 | 10 | B-13 + B-14(5/5) | Methyl benzoate |
| Example 2-19 | PE-6 | 10 | B-13 + B-14(5/5) | Methyl benzoate |
| Example 2-20 | PE-7 | 10 | B-13 + B-14(5/5) | Methyl benzoate |
| Example 2-21 | PE-8 | 10 | B-13 + B-14(5/5) | Methyl benzoate |
| Example 2-22 | AC-1 | 0.1 | B-1 | Methyl benzoate |
| Example 2-23 | AC-2 | 1 | B-1 | Ethyl benzoate |
| Example 2-24 | AC-3 | 2 | B-1 | — |
| Comparative | Dimethylsiloxane | 10 | B-2 | — |
| Example 2-1 | | | | |
| Comparative | — | — | B-3 + B-5(5/5) | — |
| Example 2-2 | | | | |
| Comparative | — | — | B-26 | — |
| Example 2-3 | | | | |
| Comparative | — | — | B-2 | — |
| Example 2-4 | | | | |

TABLE 5

| | Image ranking | Image ranking |
|---|---|---|
| | (photomemory) | (cleaning failure) |
| Example 2-1 | C | B |
| Example 2-2 | B | B |
| Example 2-3 | B | B |
| Example 2-4 | B | C |
| Example 2-5 | C | C |
| Example 2-6 | C | C |
| Example 2-7 | B | B |
| Example 2-8 | B | C |
| Example 2-9 | A | A |
| Example 2-10 | A | C |
| Example 2-11 | A | C |
| Example 2-12 | A | A |
| Example 2-13 | A | A |
| Example 2-14 | B | C |
| Example 2-15 | A | C |
| Example 2-16 | A | B |
| Example 2-17 | B | B |
| Example 2-18 | B | B |
| Example 2-19 | B | B |
| Example 2-20 | A | A |
| Example 2-21 | B | A |
| Example 2-22 | C | C |
| Example 2-23 | B | B |
| Example 2-24 | C | C |
| Comparative Example 2-1 | F | A |
| Comparative Example 2-2 | E | D |
| Comparative Example 2-3 | E | E |
| Comparative Example 2-4 | D | D |

In each of Examples 2-1 to 2-24, a high-quality image in which image defects due to cleaning failure or photomemory are suppressed was obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-241864, filed Nov. 28, 2014, which is hereby incorporated by reference herein in its entirety.

What is claimed is:

1. An electrophotographic photosensitive member comprising:
a support; and
a charge generating layer and a charge transporting layer on the support;
wherein the charge generating layer comprises:
a gallium phthalocyanine crystal in which an organic compound (P) is contained,
wherein the organic compound (P) is at least one compound selected from the group consisting of dimethylsulfoxide, N,N-dimethylformamide, N-methylformamide, N-propylformamide, N-vinylformamide and N-methylpyrrolidone,
the content of the organic compound (P) is 0.1% by mass or more and 1.5% by mass or less based on a gallium phthalocyanine in the gallium phthalocyanine crystal, and
the charge transporting layer comprises:
a resin having a siloxane structure, and
a compound (Q) having a boiling point of 150° C. or more at 1 atm.

2. The electrophotographic photosensitive member according to claim 1, wherein
the charge transporting layer further comprises a resin free from a siloxane structure, and
the content of the resin having a siloxane structure is 0.1% by mass or more and 50% by mass or less based on the total resin in the charge transporting layer.

3. The electrophotographic photosensitive member according to claim 1, wherein the content of the compound (Q) is 0.001% by mass or more and 2% by mass or less based on the total mass of the charge transporting layer.

4. The electrophotographic photosensitive member according to claim 1, wherein the compound (Q) is liquid at a temperature of 23° C. and 1 atm, and
the charge transporting layer is formed using a coating liquid comprising
the compound (Q), and
any one of toluene and xylene.

5. The electrophotographic photosensitive member according to claim 1, wherein the compound (Q) is a compound being miscible with the organic compound (P) contained in the gallium phthalocyanine crystal.

6. The electrophotographic photosensitive member according to claim 1, wherein the compound (Q) is at least one compound selected from the group consisting of ethyl benzoate, methyl benzoate, benzyl acetate, ethyl 3-ethoxypropionate, diethylene glycol ethyl methyl ether, propylene carbonate and y-butyrolactone.

7. The electrophotographic photosensitive member according to claim 1, wherein the content of the organic compound (P) is 0.3% by mass or more and 1.2% by mass or less based on a gallium phthalocyanine in the gallium phthalocyanine crystal.

8. The electrophotographic photosensitive member according to claim 1, wherein the organic compound (P) is at least one compound selected from the group consisting of N-methylformamide, N-propylformamide and N-vinylformamide.

9. The electrophotographic photosensitive member according to claim 1, wherein the gallium phthalocyanine crystal is a hydroxygallium phthalocyanine crystal or a chlorogallium phthalocyanine crystal.

10. A method for producing an electrophotographic photosensitive member,
the method comprising:
drying a coating film of a coating liquid containing the gallium phthalocyanine crystal in which an organic compound (P) is contained, to form a charge generating layer; and
drying a coating film of a coating liquid containing the resin having a siloxane structure, to form a charge transporting layer,
wherein the electrophotographic photosensitive member comprises:
a support; and
a charge generating layer and a charge transporting layer on the support;
wherein the charge generating layer comprises:
a gallium phthalocyanine crystal in which an organic compound (P) is contained,
wherein the organic compound (P) is at least one compound selected from the group consisting of dimethylsulfoxide, N,N-dimethylformamide, N-methylformamide, N-propylformamide, N-vinylformamide and N-methylpyrrolidone,
the content of the organic compound (P) is 0.1% by mass or more and 1.5% by mass or less based on a gallium phthalocyanine in the gallium phthalocyanine crystal, and
the charge transporting layer comprises:
a resin having a siloxane structure, and
a compound (Q) having a boiling point of 150° C. or more at 1 atm.

11. A process cartridge detachably attachable to a main body of an electrophotographic apparatus, wherein the process cartridge integrally supports:
an electrophotographic photosensitive member, and
at least one unit selected from the group consisting of a charging unit, a developing unit and a cleaning unit,
wherein the electrophotographic photosensitive member comprises:
a support; and
a charge generating layer and a charge transporting layer on the support;
wherein the charge generating layer comprises:
a gallium phthalocyanine crystal in which an organic compound (P) is contained,
wherein the organic compound (P) is at least one compound selected from the group consisting of dimethylsulfoxide, N,N-dimethylformamide, N-methylformamide, N-propylformamide, N-vinylformamide and N-methylpyrrolidone, the content of the organic compound (P) is 0.1% by mass or more and 1.5% by mass or less based on a gallium phthalocyanine in the gallium phthalocyanine crystal, and
the charge transporting layer comprises:
a resin having a siloxane structure, and
a compound (Q) having a boiling point of 150° C. or more at 1 atm.

12. An electrophotographic apparatus comprising:
an electrophotographic photosensitive member,
a charging unit,
an exposing unit,
a developing unit, and
a transferring unit,
wherein the electrophotographic photosensitive member comprising:
a support; and
a charge generating layer and a charge transporting layer on the support;
wherein the charge generating layer comprises:
a gallium phthalocyanine crystal in which an organic compound (P) is contained,
wherein the organic compound (P) is at least one compound selected from the group consisting of dimethylsulfoxide, N,N-dimethylformamide, N-methylformamide, N-propylformamide, N-vinylformamide and N-methylpyrrolidone,
the content of the organic compound (P) is 0.1% by mass or more and 1.5% by mass or less based on a gallium phthalocyanine in the gallium phthalocyanine crystal, and
the charge transporting layer comprises:
a resin having a siloxane structure, and
a compound (Q) having a boiling point of 150° C. or more at 1 atm.

13. An electrophotographic photosensitive member comprising:
a support; and
a charge generating layer and a charge transporting layer on the support;
wherein the charge generating layer comprises:
a gallium phthalocyanine crystal in which an organic compound (P) is contained,
wherein the organic compound (P) is at least one compound selected from the group consisting of dimethylsulfoxide, N,N-dimethylformamide, N-methylformamide, N-propylformamide, N-vinylformamide and N-methylpyrrolidone,
the content of the organic compound (P) is 0.1% by mass or more and 1.5% by mass or less based on a gallium phthalocyanine in the gallium phthalocyanine crystal, and
the charge transporting layer comprises a resin having a siloxane structure.
